(19) United States
(12) Patent Application Publication
(10) Pub. No.: US 2016/0154473 A1
(43) Pub. Date: Jun. 2, 2016

(54) ELECTRONIC APPARATUS AND METHOD

(71) Applicant: KABUSHIKI KAISHA TOSHIBA, Tokyo (JP)

(72) Inventor: Shinsuke YATO, Tokyo (JP)

(73) Assignee: KABUSHIKI KAISHA TOSHIBA, Tokyo (JP)

(21) Appl. No.: 14/828,607

(22) Filed: Aug. 18, 2015

Related U.S. Application Data
(60) Provisional application No. 62/085,396, filed on Nov. 28, 2014.

(51) Int. Cl. G06F 3/038; G06F 3/0354; G06F 3/01

(52) U.S. Cl. CPC G06F 3/038; G06F 3/016; G06F 3/03547; G06F 3/03543

(57) ABSTRACT

According to one embodiment, an electronic apparatus includes a first device and a second device. The first device includes a CPU which executes a driver of an operation input device, and a first controller. The second device includes the operation input device, and a second controller. When the first device is not electrically connected to the second device, after the driver transmits a command to the operation input device, the first controller transmits to the driver a reply to the transmitted command instead of the second controller.

### CROSS-REFERENCE TO RELATED APPLICATIONS

This application claims the benefit of U.S. Provisional Application No. 62/085,396, filed Nov. 28, 2014, the entire contents of which are incorporated herein by reference.

### FIELD

Embodiments described herein relate generally to a connection between two electronic apparatuses.

### BACKGROUND

In recent years, two electronic apparatuses are sometimes used in a state of being electrically connected with each other. In one example, a tablet computer having no keyboard (hereinafter referred to as a “tablet”) is electrically connected to a device called a keyboard dock having a keyboard, a touchpad, etc., and control signals are exchanged between the tablet and the keyboard dock. In this way, the tablet and the keyboard dock are used as if they form a single unit just like a notebook personal computer. A keyboard or a touchpad may be connected to other devices by means of a PS/2 connector. However, a tablet may not have a PS/2 connector. Instead, almost all tablets have a USB connector. Accordingly, a keyboard dock ought to be connected to a tablet through a USB connector. Therefore, when a PS/2 keyboard or a PS/2 touchpad is mounted on a keyboard dock, a PS/2 bus must be converted to a USB bus within the keyboard dock. In order to achieve a USB connection, a tablet and a keyboard dock are individually required to have a USB controller, and USB controllers are high in price and large in power consumption.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view illustrating an exemplified electronic apparatus in the embodiment.

FIG. 2 is a block diagram illustrating an exemplified system configuration of the electronic apparatus in the embodiment.

FIG. 3A is a flowchart illustrating an exemplified device setting control executed by a tablet controller.

FIG. 3B is a flowchart illustrating an exemplified device setting control executed by a keyboard dock.

FIG. 4 is a flowchart illustrating an exemplified reset operation of a touchpad while a tablet is docked to a keyboard dock.

FIG. 5A is a flowchart illustrating an exemplified process of packetizing data input from a mouse.

FIG. 5B is a timing chart illustrating the exemplified process of packetizing data input from the mouse.

### DETAILED DESCRIPTION

Various embodiments will be described hereinafter with reference to the accompanying drawings.

In general, according to one embodiment, an electronic apparatus includes a first device and a second device. The first device is electrically connected to the second device in a detachable manner. The first device includes a CPU which executes a driver to recognize and to control an operation input device, and a first controller which receives a command output from the driver to the operation input device and to control the operation input device. The second device includes the operation input device, and a second controller which receives a command transmitted from the first controller and to control the operation input device. When the first device is not electrically connected to the second device, the driver maintains a state in which the driver recognizes the operation input device of the second device to be a device connected to the first device, and after the driver transmits a command to the operation input device, the first controller transmits to the driver a reply to the transmitted command instead of the second controller.

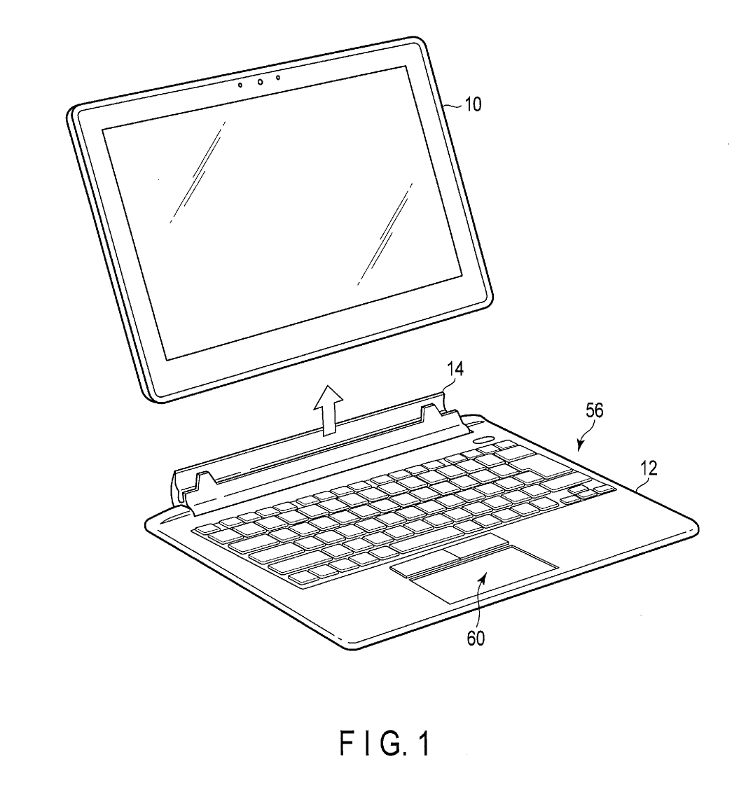

FIG. 1 is a perspective view illustrating an exemplified configuration of the electronic apparatus in the embodiment. The first device and the second device can be detachably connected to each other. The first device is a tablet 10, which allows a touch operation and does not have a hardware keyboard. The second device is a keyboard dock 12, which has a keyboard and a touchpad as the operation input device which the tablet 10 does not have. However, the first device and the second device, which are connectable to each other, are not limited to these respective devices, but they individually can be any device. Furthermore, what the second device has but the first device does not have is not limited to the operation input device but can be any device.

The tablet 10 has a thin box shaped case. The case has on its top surface a touch screen display including a flat panel display, such as a liquid crystal display (LCD), and a touch panel which is placed over the LCD and may employ an electrostatic capacitance system, for instance, to detect a touch position when a stylus or a finger touches the screen surface of the flat panel display. The tablet 10 may display a software keyboard in the touch screen display, which allows input of a character by touching a software key. Alternatively, the tablet 10 may have a function of a hand written input. The tablet 10 internally has a rechargeable battery as its power source and is driven by the rechargeable battery.

The keyboard dock 12 includes a keyboard 56 and a touchpad 60 arranged in front of the keyboard 56. The touchpad 60 moves a cursor by sliding a touch position on the pad and serves as a mouse. Furthermore, the touchpad 60 enlarges or reduces an image by changing the distance between a touch position of a thumb and that of a first finger, for instance. The touchpad 60 includes two buttons which correspond to a right and a left button of a mouse.

The keyboard dock 12 has at its deep side end a support 14 for securely supporting the tablet 10 at a predetermined angle. The tablet 10 has at least one docking port in at least one predetermined position of its lower side surface (for instance, in the case of one port, it is located in the middle, but in the case of two ports, one at its right end and the other at its left end). The tablet 10 is inserted into the support 14. The keyboard dock 12 has at least one docking connector at its deep side end located correspondingly to the at least one docking port. The docking connector has a shape of a plug including a pin. The docking port has a shape of a receptacle into which the pin is inserted. Therefore, when the tablet 10 is mounted on the support 14, the docking port will be connected to the docking connector, and the tablet 10 and the keyboard dock 12 are electrically connected with each other, producing a state similar to a state in which a notebook PC is opened. If the support 14 is provided with a hinge mechanism, the tablet 10 can be closed just like a notebook PC, as long as it is inserted in the support 14.

When the keyboard dock 12 is connected to the tablet 10, it may operate by the electricity supplied from the tablet 10. The keyboard dock 12 can be connected to a commercial power supply. Therefore, it is possible to drive the tablet 10 by commercial current supplied via the keyboard dock 12 from the commercial power supply, so long as the tablet 10 is connected to the keyboard dock 12. A rechargeable battery in the tablet 10 may be charged with commercial current via the keyboard dock 12 while the tablet 10 is docked with the keyboard dock 12. The tablet 10 has a wireless LAN device inside of it. However, it does not have a cable LAN device, an HDMI interface, or a display port. In contrast, the keyboard dock 12 has inside of it a cable LAN device, an HDMI interface, or a display port. When the tablet 10 is docked to the keyboard dock 12 with the docking port fitted with the docking connector, the tablet 10 and the keyboard dock 12 are electrically connected with each other and act as a single unit. The tablet 10 can use the cable LAN device, the HDMI interface, or the display port incorporated in the keyboard dock 12. A key signal input from the keyboard 56 of the keyboard dock 12 is transmitted to the tablet 10 and is displayed on the tablet 10.

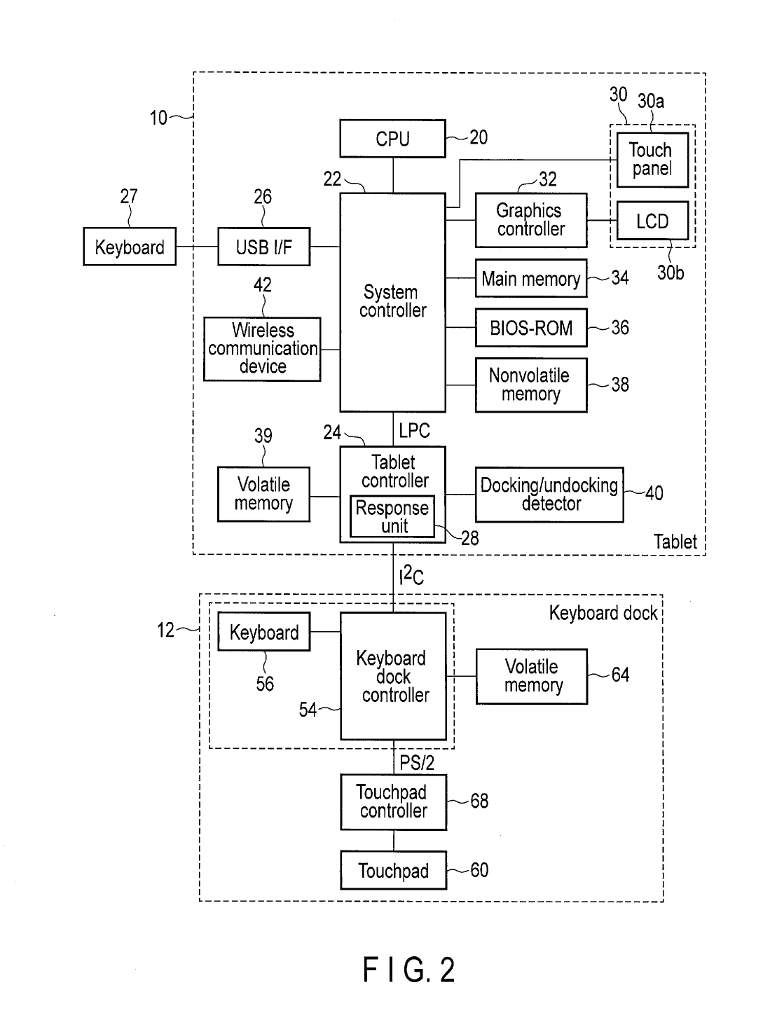

FIG. 2 is a circuit diagram illustrating an example of a whole circuit configuration of an electronic apparatus having a tablet 10 and a keyboard dock 12. The tablet 10 has a CPU 20, a system controller 22, a tablet controller 24, a USB interface 26, a touch screen display 30, a graphics controller 32, a main memory 34, a BIOS-ROM 36, a nonvolatile memory 38, a volatile memory 39, a docking/undocking detector 40, and a wireless communication device 42, etc.

The CPU 20 controls various components in the tablet 10 and various components in the keyboard dock 12. The CPU 20 executes various items of software including an operating system (OS) loaded from a storage device, i.e., the nonvolatile memory 38 to the main memory 34. The software includes software that is concerned with control of connecting the tablet 10 and the keyboard dock 12. The software includes a device driver, which recognizes an input operation device such as a keyboard, a touchpad, or a mouse, etc., and controls the recognized input operation device. The device driver supplies a control command for the operation input device to the tablet controller 24, which will be described later. The device driver receives via the tablet controller 24 the command supplied from the operation input device. The CPU 20 executes the basic input-output system (BIOS) stored in the BIOS-ROM 36. The BIOS is a program for hardware control.

The system controller 22 is a device for connecting the local bus of the CPU 20 and the various components. The system controller 22 has a memory controller for executing access control of the main memory 34. The system controller 22 also has a function of executing communication with the graphics controller 32 via, for instance, a serial bus of a PCI EXPRESS standard.

The graphics controller 32 is a display controller for controlling an LCD 30b used as a display monitor of the tablet 10. Display signals generated by the graphics controller 32 are sent to the LCD 30b. A touch panel 30a is arranged on the LCD 30b. Signals from the touch panel 30a are supplied to the system controller 22.

The USB interface 26 is for connecting a USB device such as a USB memory or a USB keyboard 27 to the tablet 10. The tablet controller 24 supplies a command from the CPU 20 to the keyboard dock 12 through an I²C bus, an example of the serial bus. The tablet controller 24 receives a signal from the keyboard dock 12, suitably processes the signal, and supplies the signal to the CPU 20. The tablet controller 24 may be realized by firmware. Therefore, power saving control will be easily realized. Hitherto, existing hardware chips are used as a USB controller at a tablet and a USE controller at a keyboard dock. As a result, it was very difficult to realize power saving control. The connection between the tablet 10 and the keyboard dock 12 is not limited to the I²C bus, but another serial bus such as a URT, etc., may be used. Furthermore, it is not limited to any serial bus, but a parallel bus may be used.

The tablet controller 24 and the system controller 22 are connected to each other by a low pin connect (LPC) bus. The tablet controller 24 also serves as an interface between the I²C bus and the LPC bus. The volatile memory 39 and the docking/undocking detector 40 are connected to the tablet controller 24.

The volatile memory 39 stores a command concerning settings (for instance, Caps Lock) of the operation input device provided at the keyboard dock 12 or setting values concerning the settings of the operation input device (for instance, a repeat speed of a keyboard). The docking/undocking detector 40 detects whether the docking port of the tablet 10 is connected to or disconnected from the docking connector of the external device. For example, the detection is based on a level change of a contact which is exclusively used for docking/undocking. The docking/undocking detector 40 outputs a signal indicative of detection result to the tablet controller 24 and the tablet controller 24 determines docking/undocking based on the signal. The determination result is supplied to the device driver. The docking/undocking detector 40 detects the connection or disconnection of the keyboard dock 12, but does not identify the devices which the docked keyboard dock 12 has. The tablet controller 24 therefore can detect whether the tablet 10 and the keyboard dock 12 are connected to or disconnected from each other. Therefore, it is possible to find that the operation input device which the keyboard dock 12 has is released from the connection with the tablet 10. However, the system controller 22 and the device driver wrongly recognize that the operation input device which the keyboard dock 12 has is always connected to the tablet 10. Therefore, when the device driver tries to control the operation input device which the keyboard dock 12 has while undocked, a malfunction or an operation lock may occur.

To solve such a problem, there is provided a response unit 28 as one of the functions of the tablet controller 24 which will be realized by a firmware. The response unit 28 operates to allow the device driver for controlling the operation input device of the keyboard dock 12 to recognize the operation input device of the keyboard dock 12. Specifically, while the tablet 10 is undocked from the keyboard dock 12, the device driver may receive from the USB keyboard 27 a command for setting the operation input device of the keyboard dock 12 and the device driver may output the received command from the tablet controller 24 to the keyboard dock 12 through the I²C bus. For instance, the device driver may receive and output a command for setting a mouse, a touchpad, or a keyboard, including a Caps Lock command of the keyboard. However, since the keyboard dock 12 is not connected to the tablet 10, the device driver never receives an Ack response. Namely, the device driver erroneously believes that the operation input device is connected to the tablet 10, but the operation input device cannot be detected nevertheless, resulting in occurrence of erroneous operation or operation lock. However, if the response unit 28 returns an Ack response to the CPU 20 in place of the operation input device connected to the keyboard dock 12, the device driver can operate as if it would find the operation input device.

The wireless communication device 42 connects the tablet 10 to a network.

The keyboard dock 12 includes a keyboard dock controller 54, a volatile memory 64, a touchpad controller 68, and an operation input device including a keyboard 56 and a touchpad 60. The keyboard dock controller 54 communicates through the I²C bus with the tablet controller 24, sets a command or a setting value from the tablet controller 24 to any one of the keyboard 56, the touchpad 60, the volatile memory 64, etc., and transmits to the tablet controller 24 the signal from any one of the keyboard 56, the touchpad 60, etc. The keyboard dock controller 54 may be realized by firmware in the same way as the tablet controller 24.

The keyboard dock controller 54 controls the touchpad 60 through the touchpad controller 68. Namely, the keyboard dock controller 54 is not configured to directly control the touchpad 60. The keyboard 56 and the keyboard dock controller 54 are regarded as a single unit in terms of a device (they are connected with each other not by a digital communication bus but by a dedicated scan signal line). The keyboard 56 supplies a key scan signal and a return signal to the keyboard dock controller 54. The keyboard 56 is directly controlled by the keyboard dock controller 54. The touchpad controller 68 and the keyboard dock controller 54 are connected with each other by the PS/2 bus. The keyboard dock controller 54 also serves as an interface between the PS/2 bus and the I²C bus. The volatile memory 64 stores data concerning the setting of the keyboard 56 or the touchpad 60.

In the embodiment, when the tablet 10 is docked with the keyboard dock 12, they are connected to each other not by the conventional USB bus but by the I²C bus, one example of a serial bus. Since the connection is established by the I²C bus, it is required to provide the tablet 10 with the tablet controller 24 and the keyboard dock 12 with the keyboard dock controller 54 for the establishment of an interface between the I²C bus and the internal bus (for instance, an LPC bus or a PS/2 bus). These controllers are lower than USB controllers in cost and power consumption. The tablet controller 24 and the keyboard dock controller 54 may be realized by a firmware, so that a much lower power consuming control can be easily realized.

As described above, the utilization of an I²C bus is superior to the utilization of an USB bus in terms of power consumption. However, the I²C bus does not fit for plug & play. When a device has a plug & play function, the device driver correctly detects connection or disconnection of the device. Therefore, when the tablet 10 is connected to the keyboard dock 12, the connection or disconnection of the device connected to the keyboard dock 12 will be detected. However, in the case of the keyboard dock 12 that is connected through the I²C bus, the device driver can detect the attachment or detachment of the keyboard dock 12, but can not detect the connection or disconnection of the devices connected to the keyboard dock 12 and wrongly determines that they are always in a connected state. On the other hand, when the USB keyboard 27 is connected to the tablet 10, the CPU 20 is configured to transmit to all the keyboards connected to the tablet 10 a command concerning settings of the keyboard having been set by the USB keyboard 27 (for instance, an upper case lock (caps lock) command) and to receive an Ack response from each of the keyboards connected to the tablet 10. Therefore, even if the tablet 10 is undocked from the keyboard dock 12, once a caps lock command is generated from the USB keyboard 27, the CPU 20 transmits the caps lock command through the tablet controller 24 to the keyboard dock 12 which is not actually connected but is wrongly recognized as being connected. Since an Ack response is not returned from the keyboard dock 12 however long the CPU 20 waits, the CPU 20 detects an error, and the status of an object device is not certain.

In the embodiment, when the OS receives a key status change from the USB keyboard 27 while being in an undocked state and then the OS issues a command concerning a keyboard setting, the device driver which is realized by software executed by the CPU 20 outputs the command to the tablet controller 24. However, since the keyboard dock 12 is not connected to the tablet 10, the command is not transmitted to the keyboard 56 and an Ack response is not returned from the keyboard 56. At this moment, the response unit 28 of the tablet controller 24 responds to the command output from the tablet controller 24 instead of the keyboard 56. Thus, an Ack response is returned to the device driver. In this way, the possibility of an occurrence of an erroneous operation of the device driver, which is realized by the software executed by the CPU 20, will be easily prevented by (the response unit 28 of) the tablet controller 24, which is realized by the firmware. Although any physical device (a keyboard or a touchpad) is not present while being in an undocked state, the response unit 28 of the tablet controller 24 responds to any command from the CPU (a host (Driver/BIOS)) 20 as if a physical device is present, so that inconsistency in device driver will never occur. While being in a docked state, the command output from the tablet controller 24 is transmitted to the keyboard dock 12 and an Ack response is actually returned to the tablet 10 from a device in the keyboard dock 12. Furthermore, while being in a docked state, a signal output from a device of the keyboard dock 12 (a keyboard 56 or a touchpad 60) is transmitted from the keyboard dock controller 54 to the tablet controller 24.

The setting status instructed by a command, which the device driver receives while being in an undocked state concerning a setting of a device of the keyboard dock 12, may be inconsistent with the actual status of a device of the keyboard dock 12 having been set up while being in an undocked state. The tablet controller 24 therefore stores into the volatile memory 39 any commands, setting values, etc., which the tablet controller 24 has received while being in an undocked state. After has been docked, the tablet controller 24 reads them from the volatile memory 39, sends them to the keyboard dock 12, and sets them through the keyboard dock controller 54 to the respective devices such as the keyboard 56. This makes it possible to make the settings by the tablet 10 consistent with the status of the keyboard dock 12.

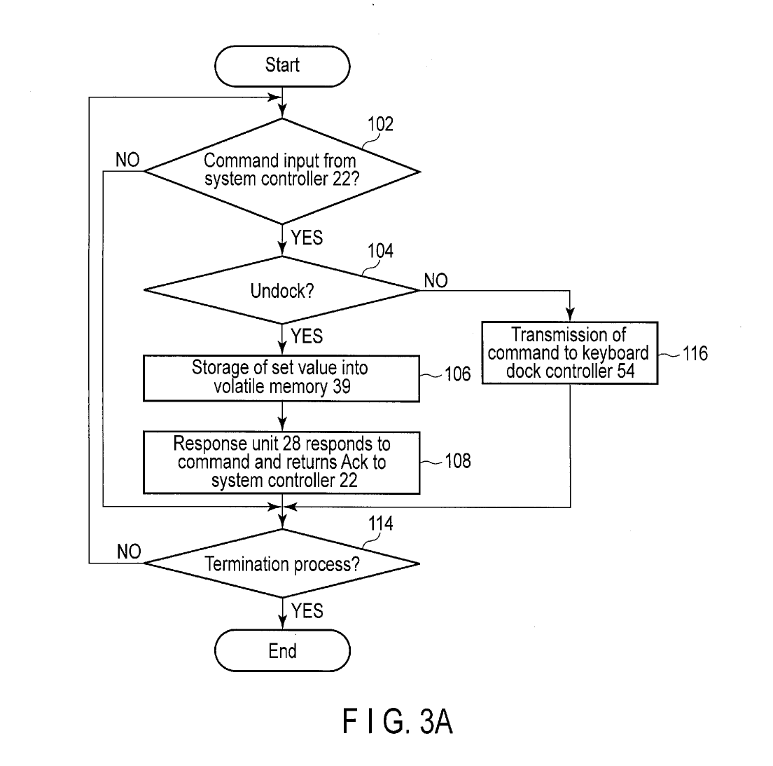

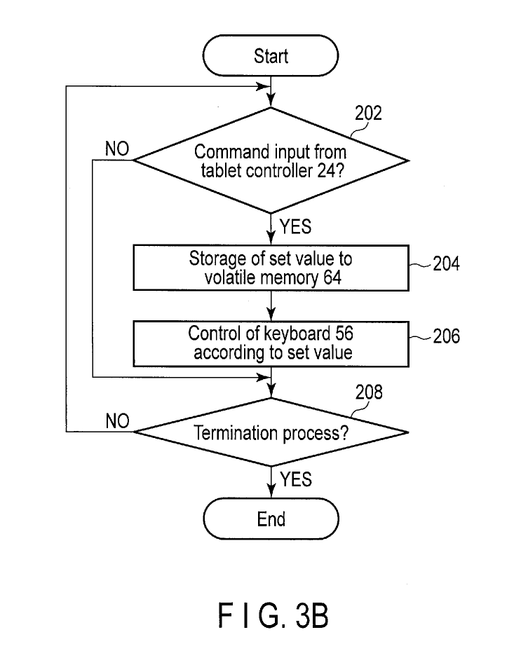

FIG. 3A is a flowchart illustrating an exemplified device setting control executed by the tablet controller 24 in a docked state or an undocked state. FIG. 3B is a flowchart illustrating an exemplified device setting control executed by the keyboard dock controller 54. The device driver executed by the CPU 20 causes the system controller 22 to transmit a command to the keyboard dock 12 via the tablet controller 24. The tablet controller 24 determines whether or not the command concerning the settings of the keyboard is input at Block 102. When the input of a command is detected, the process branches depending on a status previously detected by the docking/undocking detector 40 (Block 104). When no command is input, the process advances to Block 114 and it is determined whether or not the operation should end. The completion of the operation is determined based on the power source status, and the moment when the system power source is turned off is determined as completion. When not completion, the process returns to the command input check in Block 102.

When being in an undocked state, the tablet controller 24 stores into the volatile memory 39 the set value of the command concerning the keyboard settings in Block 106. For instance, the setting value of the Caps Lock command is stored into the volatile memory 39. In this way, the setting information concerning the keyboard setting which the tablet 10 receives while being in an undocked state is stored in the volatile memory 39 of the tablet 10. The command input from the CPU 20 is supplied to the response unit 28 of the tablet controller 24. In Block 108, the response unit 28 responds to the command and returns an Ack reply to the device driver. The device driver receives the Ack reply, which causes the device driver to believe that the keyboard 56 is connected. Therefore, it becomes possible to move forward to the next step.

When the docking between the tablet 10 and the keyboard dock 12 is detected in Block 104, the tablet controller 24 transmits the input command to the keyboard dock 12 in Block 116. At the keyboard dock 12, the keyboard dock controller 54 determines in Block 202 illustrated in FIG. 3B whether the command concerning the settings of the keyboard is input from the tablet controller 24. When the input of a command is detected, the keyboard dock controller 54 stores the setting value for the transmitted command to the volatile memory 64 (Block 204). In Block 206, the keyboard dock controller 54 sets the keyboard 56 according to the data in the volatile memory 64. In Block 208, whether the operation is completed or not is determined based on the power status of the system. When not completed, the process returns to the command input check in Block 202.

According to this method, it is possible to read from the volatile memory 39 the setting information, which concerns the settings of a keyboard and which the tablet 10 receives while the tablet 10 is in an undocked state, and to set the setting information to the keyboard after the keyboard dock 12 has been connected to the tablet 10. This makes it possible to prevent discrepancy in status between the keyboard dock 12 and the tablet 10 from occurring when they are docked with each other even if inconsistency in status has been actually occurred between them while they are in an undocked state. Therefore, even though the keyboard dock 12 including the keyboard 56 is connected to the tablet 10 not by the USB bus but by the I²C bus, the device settings of the keyboard dock 12 can be suitably adjusted through the I²C bus by the tablet 10 as soon as the keyboard dock 12 is connected to the tablet 10. Therefore, the setting status of a device connected to the keyboard dock 12, such as the keyboard 56 or the touchpad 60, can be made consistent with the status set by the tablet 10.

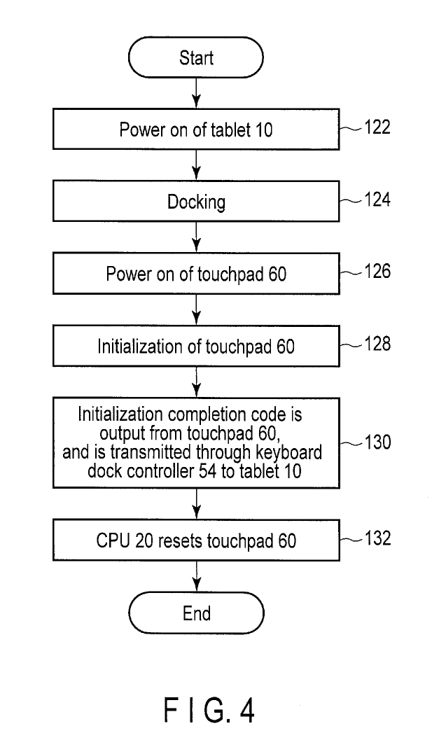

FIG. 4 is a flowchart illustrating an exemplified operation for setting the touchpad 60 while the tablet 10 is docked with the keyboard dock 12. Let us suppose that, after the tablet 10 is powered on in Block 122, the tablet 10 is docked with the keyboard 12 in Block 124. When the docking is detected, the CPU 20 causes the touchpad 60 to be powered on in Block 126. The touchpad 60 is powered off while undocked. When the touchpad 60 is powered on, it executes initialization (Block 128). The initialization causes the device setting values and the operation mode to be return to an initial. state. In Block 130, the initialization completion code (a BAT code) is output from the touchpad 60, and is transmitted through the keyboard dock controller 54 to the tablet controller 24. When the CPU 20 of the tablet 10 receives the initialization completion code, it sends instruction of setting the touchpad 60 through the keyboard dock controller 54 to the touchpad controller 68 in Block 132. The touchpad 60 will be suitably set at a time of docking.

Concerning the communication by a device connected to the keyboard dock 12, it must be considered that the device is brought into an undocked state while communicating. Though data is generally transferred from the PS/2 device with every one byte, an abnormal data transmission will be prevented by transmitting data by a unit of a meaningful block from the keyboard dock controller 54 to the tablet controller 24. In the I²C communication, a start code, an address, an item of data and a stop code are transmitted with every data communication, it will be inefficient to send to the tablet 10 one byte of scan data at a time. The keyboard scan data may therefore be packetized not in unit of one byte but in unit of one key, and then is transmitted from the keyboard dock controller 54 to the tablet controller 24. A Make code and a Break code, each including a plurality of bytes, are individually transmitted as a separate single packet. This makes it possible to collectively send an item of scan data consisting of a plurality of bytes in an efficient manner.

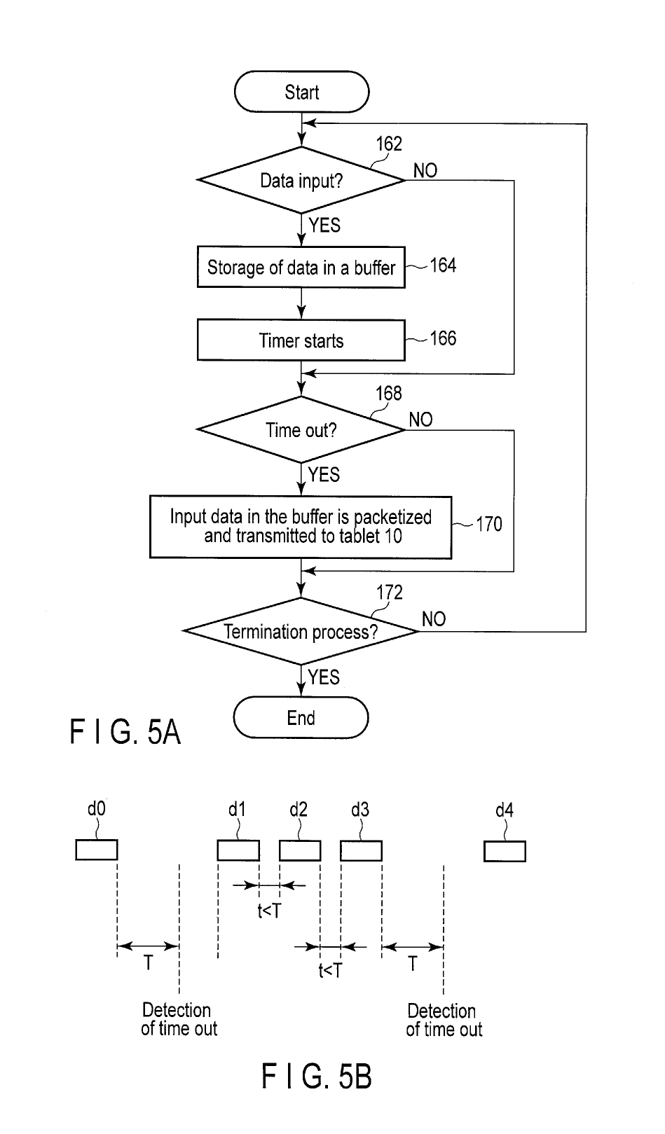

The keyboard scan data is determined in its byte format. However, it is uncertain that in what byte format the data from the touchpad 60 is transmitted because of an internal operation mode. FIG. 5A is a flowchart illustrating an exemplified process for packetizing data generated from the touchpad 60 and transmitted from the keyboard dock controller 54 to the tablet controller 24. The keyboard dock controller 54 waits for data to be input from the touchpad 60 in Block 162. When it receives data, it stores the data in an internal buffer in Block 164, and causes a timer to start in Block 166. The keyboard dock controller 54 determines whether the timer counting a certain period has timed out in Block 168. When it has not yet timed out, the keyboard dock controller 54 determines the completion of the process in Block 172 and the process returns to Block 162.

The timer begins to count after one-byte data has been input. Therefore, the timer counts an elapsed time immediately after the completion of a one-byte data input operation. Detection of a time-out in Block 168 indicates as illustrated in FIG. 5B that it has passed more than a predetermined time T since the input of an immediately preceding one-byte data item d3 has been completed till the input of an immediately following data item d4 begins, and that data input becomes discontinuous. Therefore, data items d1 to d3 that have been input since the detection of the last time-out can be regarded as a continuum, and thus in Block 170 data items d1 to d3 that have been hitherto input are packetized and are transmitted to the tablet controller 24. In Block 172 after Block 170, it is determined whether the operation is completed or not based on the power status of the system. When it is not completed yet, the process returns to the data input check in Block 162.

In this way, any one-byte data item having been input within a predetermined time since the completion of inputting an immediately preceding data item is regarded as continuing from the immediately preceding one-byte data item in the data items having been input by every one byte, and a group of data items regarded as a continuum are collectively transmitted to the tablet controller 24 as a packet. In this way, several scan data are packetized as a meaningful unit, which makes it possible to collectively transmit the several scan data in a packet unit, achieving an efficient data transmission.

As has been explained above, when a tablet and a keyboard dock are detachably connected to each other with the use of a communication bus which does not fit for a plug-and-play connection, the device driver of the tablet cannot recognize the connection or disconnection of a device incorporated in the keyboard dock and thus transmits a command to the device incorporated in the keyboard dock even if the device is disconnected. In such a case, the tablet controller responds in place of the disconnected device, so that the device driver will work correctly. The setting commands which the device driver has received while being disconnected will be transmitted to the keyboard dock at a time of connection, making the setting status of a device connected to the keyboard dock, such as a keyboard or a touchpad, consistent with the status having been set at the tablet. Therefore, just connecting the keyboard dock with the tablet is all that is needed to use the keyboard dock. Since no USB bus is used to connect the tablet to the keyboard dock, power consumption and cost will be greatly reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising a first device and a second device, wherein
the first device is electrically connected to the second device in a detachable manner,
the first device comprises a CPU which executes a driver to recognize and to control an operation input device, and a first controller which receives a command output from the driver to the operation input device and to control the operation input device,
the second device comprises the operation input device, and a second controller which receives a command transmitted from the first controller and to control the operation input device, and
when the first device is not electrically connected to the second device, the driver maintains a state in which the driver recognizes the operation input device of the second device to be a device connected to the first device, and after the driver transmits a command to the operation input device, the first controller transmits to the driver a reply to the transmitted command instead of the second controller.

2. The electronic apparatus of claim 1, wherein
the first device comprises a memory, and
when the first device is not electrically connected to the second device, after the first controller receives a command supplied to the operation input device while the first device is not electrically connected to the second device, the first controller stores the received command into the memory, and after the first device is electrically connected to the second device, the first controller supplies to the second controller the command having been read from the memory.

3. The electronic apparatus of claim 1, wherein
when the first device is electrically connected to the second device, the operation input device executes an initialization process and transmits an initialization completion signal to the driver after the initialization process has completed, and
the driver sets the operation input device in response to the initialization completion signal.

4. The electronic apparatus of claim 1, wherein
the operation input device comprises a keyboard, and
the second controller recognizes scan data from the keyboard, separately packetizes first scan data indicating that a key is pressed down and second scan data indicating that a key is released into respective packets, and transmits the respective packets to the first controller.

5. The electronic apparatus of claim 1, wherein
the operation input device comprises a touchpad or a mouse, and
the second controller packetizes data having been output from the touchpad or the mouse but not having been transmitted yet and transmits each packet to the first controller when a not-yet-output period of data intermittently output from the touchpad or the mouse lasts more than a predetermined period.

6. The electronic apparatus of claim 1, wherein
the first device comprises a tablet and a detector configured to detect connection or disconnection of an electronic contact with the second device, and
the operation input device comprises a touchpad or a mouse and a keyboard.

7. The electronic apparatus of claim 1, wherein
the first controller is connected to the second controller by an I²C bus.

8. A method for connecting a first device to a second device, wherein
the first device is electrically connected to the second device in a detachable manner,
the first device comprises a CPU which executes a driver to recognize and to control an operation input device, and a first controller which receives a command output from the driver to the operation input device and to control the operation input device, and
the second device comprises the operation input device, and a second controller which receives a command transmitted from the first controller and to control the operation input device, the method comprising:
when the first device is not electrically connected to the second device, after transmitting, by the driver, a command to the operation input device, transmitting, by the first controller, to the driver a reply to the transmitted command instead of the second controller.

9. The method of claim 8, wherein
when the first device is not electrically connected to the second device, after the first controller receives a command supplied to the operation input device while the first device is not electrically connected to the second device, storing, by the first controller, the received command into a memory, and
after the first device is electrically connected to the second device, supplying, by the first controller, to the second controller the command having been read from the memory.

10. The method of claim 8, wherein
when the first device is electrically connected to the second device, executing, by the operation input device, an initialization process and transmitting an initialization completion signal to the driver after the initialization process has completed, and
setting, by the driver, the operation input device in response to the initialization completion signal.

11. The method of claim 8, wherein
recognizing, by the second controller, scan data from a keyboard, separately packetizing first scan data indicating that a key is pressed down and second scan data indicating that a key is released into respective packets, and transmitting the respective packets to the first controller.

12. The method of claim 8, wherein
packetizing, by the second controller, data having been output from a touchpad or a mouse but not having been transmitted yet and transmitting each packet to the first controller when a not-yet-output period of data intermittently output from the touchpad or the mouse lasts more than a predetermined period.

13. The method of claim 8, wherein the first controller is connected to the second controller by an I²C bus.
